(19) United States
(12) Patent Application Publication
(10) Pub. No.: US 2025/0243058 A1
(43) Pub. Date: Jul. 31, 2025

(54) METHOD FOR PREPARING 7N TELLURIUM

(71) Applicant: KUNMING UNIVERSITY OF SCIENCE AND TECHNOLOGY, Yunnan Province (CN)

(72) Inventors: Wenlong JIANG, Yunnan Province (CN); Bin YANG, Yunnan Province (CN); Qijin LUO, Yunnan Province (CN); Baoqiang XU, Yunnan Province (CN); Guozheng ZHA, Yunnan Province (CN); Dachun LIU, Yunnan Province (CN); Yang TIAN, Yunnan Province (CN); Yifu LI, Yunnan Province (CN); Lingxin KONG, Yunnan Province (CN); Xiangfeng KONG, Yunnan Province (CN); Huan LUO, Yunnan Province (CN); Heng XIONG, Yunnan Province (CN); Fei WANG, Yunnan Province (CN); Jian WU, Yunnan Province (CN); Zhaowang DONG, Yunnan Province (CN)

(21) Appl. No.: 18/770,198

(22) Filed: Jul. 11, 2024

(30) Foreign Application Priority Data
Jan. 25, 2024 (CN) 202410102336.2

(51) Int. Cl. C01B 19/02

(52) U.S. Cl. CPC C01B 19/02; C01P 2006/80

(57) ABSTRACT

Provided is a method for preparing 7N tellurium, including the following steps: mixing 2N crude tellurium with concentrated sulfuric acid, and subjecting a resulting mixture to oxidation roasting to obtain a selenium dioxide vapor and a roasting residue; mixing the roasting residue with a strong base solution, and subjecting a resulting solution to electrolysis to obtain 4N electrolytic tellurium; subjecting the 4N electrolytic tellurium to vacuum distillation to obtain 5N tellurium; and melting the 5N tellurium to obtain a tellurium melt, immersing a crystallizer in the tellurium melt, and subjecting the tellurium melt to crystallization to obtain the 7N tellurium; wherein the method is performed for a total time of less than 14 days.

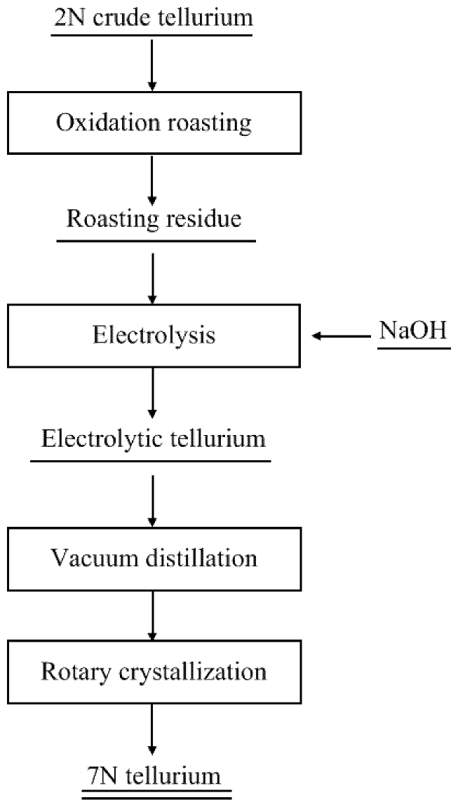

### CROSS REFERENCE TO RELATED APPLICATION

This patent application claims the benefit and priority of Chinese Patent Application No. 2024101023362 filed with the China National Intellectual Property Administration on Jan. 25, 2024, the disclosure of which is incorporated by reference herein in its entirety as part of the present application.

### TECHNICAL FIELD

The present disclosure relates to the field of high-purity metal preparation, and particularly relates to a method for preparing 7N tellurium.

### BACKGROUND

Tellurium, as a rare dispersed element, is widely used in fields such as semiconductors, chemical engineering, metallurgy, medicine, and photovoltaics. Tellurium extracted from an anode sludge is generally metallurgical-grade crude tellurium with a purity of 98% to 99%, which cannot meet the requirements of new materials.

An eco-friendly and efficient purification of crude tellurium to improve an added value of the crude tellurium has become an urgent problem to be solved by tellurium producers worldwide. Chemical methods for purificating crude tellurium include an oxidation-reduction method, a selective precipitation method, and an electrolysis method. In these chemical purification methods, based on difference between tellurium and impurity elements in chemical properties, chemical reagents are added to produce intermediate compounds, thereby separating impurities. Although high-purity tellurium prepared by a chemical purification method can have a satisfactory purity, elements need to be repeatedly oxidized and reduced during purification process, which involves toxic and harmful substances and causes great potential safety hazards and waste treatment problems. Therefore, a physical method is often used in prior art to prepare high-purity tellurium.

A major physical method for preparing high-purity tellurium is a zone melting method. During zone melting process, no reagent is added, and thus no impurities will be introduced. However, the zone melting method is very time-consuming (about 2 to 3 weeks) and has a low production rate. Moreover, the zone melting method also has a requirement for a purity of crude tellurium, and only crude tellurium with a purity of 4 N or higher can be used to obtain a high-purity metal.

### SUMMARY

An object of the present disclosure is to provide a method for preparing 7N tellurium. The method of the present disclosure is time-saving, and has low requirements for raw materials.

To achieve the above object, the present disclosure provides the following technical solutions:

The present disclosure provides a method for preparing 7N tellurium, including the following steps:
mixing 2N crude tellurium with concentrated sulfuric acid, and subjecting a resulting mixture to oxidation roasting to obtain a selenium dioxide vapor and a roasting residue;
mixing the roasting residue with a strong base solution, and subjecting a resulting solution to electrolysis to obtain 4N electrolytic tellurium;
subjecting the 4N electrolytic tellurium to vacuum distillation to obtain 5N tellurium; and
melting the 5N tellurium to obtain a tellurium melt, and immersing a crystallizer in the tellurium melt, and subjecting the tellurium melt to crystallization to obtain the 7N tellurium;
wherein the method is performed for a total time of less than 14 days.

In some embodiments, a mass ratio of the 2N crude tellurium to the concentrated sulfuric acid is in a range of (1-3):1, and a mass concentration of the concentrated sulfuric acid is 98%.

In some embodiments, the oxidation roasting is conducted at a temperature of 350° C. to 600° C. for 0.5 h to 3 h.

In some embodiments, in the resulting solution, a concentration of tellurium is in a range of 100 g/L to 300 g/L and a concentration of the strong base is in a range of 90 g/L to 130 g/L.

In some embodiments, the electrolysis is conducted at a temperature of 30° C. to 50° C. for 50 h to 110 h with a current density of 45 A/m² to 55 A/m²; and
during the electrolysis, the resulting solution is in a circulating state with a circulating rate of 1 mL/s to 5 mL/s.

In some embodiments, the vacuum distillation is conducted at a temperature of 450° C. to 600° C. and a vacuum degree of 0 Pa to 100 Pa.

In some embodiments, the tellurium melt has a temperature of 460° C. to 560° C.

In some embodiments, an immersion depth of the crystallizer is 50 mm to 100 mm below a liquid level of the tellurium melt.

In some embodiments, the crystallizer has an initial temperature of 460° C. to 500° C., and after the crystallizer is immersed for 10 min to 60 min, a temperature of the crystallizer is reduced to 420° C. to 440° C.

In some embodiments, the crystallization includes static crystallization and rotary crystallization, and a rotational speed for the rotary crystallization is less than 120 r/min.

The method for preparating 7N tellurium provided in the present disclosure includes the following steps: mixing 2N crude tellurium with concentrated sulfuric acid, and subjecting a resulting mixture to oxidation roasting to obtain a selenium dioxide vapor and a roasting residue; mixing the roasting residue with a strong base solution, and subjecting a resulting solution to electrolysis to obtain 4N electrolytic tellurium; subjecting the 4N electrolytic tellurium to vacuum distillation to obtain 5N tellurium; and melting the 5N tellurium to obtain a tellurium melt, immersing a crystallizer in the tellurium melt, and subjecting the tellurium melt to crystallization to obtain the 7N tellurium, wherein the method is performed for a total time of less than 14 days. In some embodiments of the present disclosure, an oxidation roasting-electrolysis-vacuum distillation-crystallization combined process is adopted to prepare 7N tellurium from 2N tellurium with a high impurity content, which involves a simple process flow and has low requirements for production equipment. Results in examples show that in the present disclosure, a ultra-high-purity tellurium with a purity of 99.99999% could be obtained.

### BRIEF DESCRIPTION OF THE DRAWINGS

FIGURE shows a process flow diagram of the method according to an embodiment of the present disclosure.

### DETAILED DESCRIPTION OF THE EMBODIMENTS

The present disclosure provides a method for preparating 7N tellurium, including the following steps:
mixing 2N crude tellurium with concentrated sulfuric acid, and subjecting a resulting mixture to oxidation roasting to obtain a selenium dioxide vapor and a roasting residue;
mixing the roasting residue with a strong base solution, and subjecting a resulting solution to electrolysis to obtain 4N electrolytic tellurium;
subjecting the 4N electrolytic tellurium to vacuum distillation to obtain 5N tellurium; and
melting the 5N tellurium to obtain a tellurium melt, immersing a crystallizer in the tellurium melt, and subjecting the tellurium melt to crystallization to obtain the 7N tellurium.

In the present disclosure, 2N crude tellurium is mixed with concentrated sulfuric, and a resulting mixture is subjected to oxidation roasting to obtain a selenium dioxide vapor and a roasting residue.

In some embodiments of the present disclosure, a mass ratio of the 2N crude tellurium to the concentrated sulfuric acid is in a range of (1-3):1 and preferably (1.5-2):1; and a mass concentration of the concentrated sulfuric acid is 98%.

In some embodiments of the present disclosure, the oxidation roasting is conducted at a temperature of 350° C. to 600° C., preferably 400° C. to 550° C., and more preferably 450° C. to 500° C.; and the oxidation roasting is conducted for 0.5 h to 3 h, preferably 1 h to 2.5 h, and more preferably 1.5 h to 2 h. The oxidation roasting is intended to remove selenium in the raw material to obtain low-selenium tellurium dioxide.

In some embodiments of the present disclosure, the oxidation roasting is conducted in a rotary roasting furnace. Under the condition that the roasting is conducted in a rotating state, materials can be fully mixed, and a selenium removal efficiency can be improved.

In the present disclosure, after the roasting residue is obtained, the roasting residue is mixed with a strong base solution, and a resulting solution is subjected to electrolysis to obtain 4N electrolytic tellurium.

In some embodiments of the present disclosure, in the resulting solution, a concentration of tellurium is in a range of 100 g/L to 300 g/L, preferably 150 g/L to 250 g/L, and more preferably 180 g/L to 220 g/L; and a concentration of the strong base is in a range of 90 g/L to 130 g/L and preferably 100 g/L to 120 g/L; and the strong base includes sodium hydroxide.

In some embodiments of the present disclosure, the electrolysis is conducted at 30° C. to 50° C. and preferably 40° C. to 45° C.; the electrolysis is conducted for 50 h to 110 h, preferably 60 h to 100 h, and more preferably 80 h to 90 h; the electrolysis is conducted with a current density of 45 A/m² to 55 A/m² and preferably 48 A/m² to 50 A/m²; and an anode used for the electrolysis is an ordinary steel plate, and a cathode used for the electrolysis is a stainless steel.

In some embodiments of the present disclosure, during the electrolysis, the resulting solution is in a circulating state with a circulating rate of 1 mL/s to 5 mL/s and preferably 2 mL/s to 4 mL/s. The resulting solution passes through a cathode chamber and a separator successively, then flows into an anode chamber, then flows out of an electrolytic cell, and is collected and sent to liquid purification system to be adjusted to change electrolyzed solution into original solution again, and then enters the cathode chamber for circulation.

In the present disclosure, after the 4N electrolytic tellurium is obtained, the 4N electrolytic tellurium is subjected to vacuum distillation to obtain 5N tellurium.

In some embodiments of the present disclosure, the vacuum distillation is conducted at 450° C. to 600° C. and preferably 500° C. to 550° C.; the vacuum distillation is conducted for 120 min to 180 min and preferably 150 min to 160 min; and the vacuum distillation is conducted at a vacuum degree of 0 Pa to 100 Pa, preferably 20 Pa to 80 Pa, and more preferably 40 Pa to 60 Pa.

In the present disclosure, after the 5N tellurium is obtained, the 5N tellurium is melted to obtain a tellurium melt, and a crystallizer is immersed in the tellurium melt, and the tellurium melt is subjected to crystallization to obtain the 7N tellurium.

In some embodiments of the present disclosure, the melting is conducted under oxygen-free conditions. The melting conducted under oxygen-free conditions can prevent tellurium from being oxidized. In some embodiments of the present disclosure, the melting is also conducted at a micro-negative pressure or atmospheric pressure, and a pressure of the micro-negative pressure is 60,000 pa to 80,000 pa.

In some embodiments of the present disclosure, the tellurium melt has a temperature of 460° C. to 560° C.

In some embodiments of the present disclosure, an immersion depth of the crystallizer is 50 mm to 100 mm and preferably 60 mm to 80 mm below a liquid level of the tellurium melt; an initial temperature of the crystallizer is 460° C. to 500° C. and preferably 470° C. to 480° C.; and after the crystallizer is immersed for 10 min to 60 min, preferably 20 min to 50 min, and more preferably 30 min to 40 min, a temperature of the crystallizer is reduced to 420° C. to 440° C. After the crystallizer is immersed in the tellurium melt, due to a temperature difference between the crystallizer and the tellurium melt, the tellurium melt will be solidified on the crystallizer, and a solidified solid can be completely melted 10 min to 60 min later.

In some embodiments of the present disclosure, the crystallization includes static crystallization and rotary crystallization; and a rotational speed of the crystallizer during the static crystallization is 0. In some embodiments of the present disclosure, the rotary crystallization is conducted through melt rotation, and a rotational speed for the rotary crystallization is less than 120 r/min; and the melt rotation is driven by a melt container, and a speed of the melt container is the rotational speed. In some embodiments of the present disclosure, the melt container includes a graphite crucible.

In some embodiments of the present disclosure, the rotary crystallization is conducted for 65 min to 130 min, preferably 80 min to 120 min, and more preferably 90 min to 100 min.

In some embodiments of the present disclosure, the rotary crystallization is conducted under oxygen-free conditions; and preferably conducted at a micro-negative pressure or a normal pressure, and a pressure of the micro-negative pressure is 60,000 pa to 80,000 pa.

In some embodiments of the present disclosure, a structure of the crystallizer includes a center layer configured to input a cooling medium and a shell layer configured to output a cooling medium; and the cooling medium includes air.

A process flow diagram of the method according to an embodiment of the present disclosure is shown in FIGURE, including: 2N crude tellurium is subjected to oxidation roasting to obtain a roasting residue; the roasting residue is mixed with a strong base solution, and a resulting solution is subjected to electrolysis to obtain 4N electrolytic tellurium; and the 4N electrolytic tellurium is subjected to vacuum distillation and then rotary crystallization to obtain 7N tellurium.

The method for preparing 7N tellurium provided by the present disclosure is described in detail below with reference to examples, but the examples should not be construed as limiting the scope of the present disclosure.

### Example 1

1,000 g of 2N crude tellurium was weighed and placed into a rotary roasting furnace, 500 mL of sulfuric acid with a mass concentration of 98% was added thereto, and a protective gas was introduced, and a resulting mixture was then subjected to oxidation roasting (at a temperature of 550° C. for 2 h).

After the oxidation roasting was completed, a low-selenium tellurium dioxide was taken out, and mixed as a raw material with sodium hydroxide to prepare a solution (in which a concentration of tellurium was 120 g/L and a concentration of sodium hydroxide was 96 g/L), and the solution was subjected to electrolysis (the electrolysis was conducted for 48 h at a temperature of 30° C. with a current density of 55 A/m²; a circulating rate of the solution was 5 mL/s; the solution first passed through a cathode chamber and a separator successively, then flowed into an anode chamber, then flowed out of an electrolytic cell, and is collected and sent to liquid purification system to be adjusted to change electrolyzed solution into original solution again, and then enters the cathode chamber for circulation; and an anode used for the electrolysis was an ordinary steel plate, and a cathode used for the electrolysis was a stainless steel) to obtain electrolytic tellurium with a purity of 99.99%.

The electrolytic tellurium was added into a quartz crucible, the quartz crucible was placed into a vacuum distillation furnace at 500° C., the vacuum distillation furnace was vacuumed to a vacuum degree of 5 Pa, and vacuum distillation was conducted for 120 min to obtain 5N tellurium with a purity of 99.9995%.

The 5N tellurium obtained after the vacuum distillation was added as a raw material into a graphite crucible, the graphite crucible was placed into a rotary crystallization furnace, the 5N tellurium was melted in a protective gas atmosphere and subjected to rotary crystallization at a micro-negative pressure of 70,000 Pa (an immersion depth of a crystallizer in a melt was 50 mm; a temperature of the melt was 482° C.; after the crystallizer with an initial temperature of 470° C. was immersed in the melt for 45 min, compressed air at 20° C. was introduced into the crystallizer for cooling to a desired crystallization temperature of 425° C.; a rotational speed of the graphite crucible was 60 r/min; and the rotary crystallization was conducted for 120 min) to obtain 7N ultra-high-purity tellurium, which was stripped from the crystallizer after the rotary crystallization.

### Example 2

1,260 g of 2N metallurgical-grade crude tellurium was weighed and placed into a rotary roasting furnace, 600 mL of sulfuric acid with a mass concentration of 98% was added thereto, and a protective gas was introduced, and a resulting mixture was then subjected to oxidation roasting (at a temperature of 550° C. for 180 min).

After the oxidation roasting was completed, a low-selenium tellurium dioxide was taken out, and mixed as a raw material with sodium hydroxide to prepare a solution (in which a concentration of tellurium was 150 g/L and a concentration of sodium hydroxide was 90 g/L), and the solution was subjected to electrolysis (the electrolysis was conducted for 48 h at a temperature of 32° C. with a current density of 55 A/m²; a circulating rate of the solution was 5 mL/s; the solution first passed through a cathode chamber and a separator successively, then flowed into an anode chamber, then flowed out of an electrolytic cell, and is collected and sent to liquid purification system to be adjusted to change electrolyzed solution into original solution again, and then enters the cathode chamber for circulation; and an anode used for the electrolysis was an ordinary steel plate, and a cathode used for the electrolysis was a stainless steel) to obtain electrolytic tellurium with a purity of 99.996%.

The electrolytic tellurium was added into a quartz crucible, the quartz crucible was placed into a vacuum distillation furnace at 450° C., the vacuum distillation furnace was vacuumed to a vacuum degree of 10 Pa, and vacuum distillation was conducted for 150 min to obtain 5N tellurium with a purity of 99.9997%.

The 5N tellurium obtained after the vacuum distillation was added as a raw material into a graphite crucible, the graphite crucible was placed into a rotary crystallization furnace, the 5N tellurium was melted in a protective gas atmosphere and subjected to rotary crystallization at a micro-negative pressure of 75,000 Pa (an immersion depth of a crystallizer in a melt was 60 mm; a temperature of the melt was 482° C.; after the crystallizer with an initial temperature of 470° C. was immersed in the melt for 45 min, compressed air at 20° C. was introduced into the crystallizer for cooling to a desired crystallization temperature of 430° C.; a rotational speed of the graphite crucible was 65 r/min; and the rotary crystallization was conducted for 90 min) to obtain 6N8 ultra-high-purity tellurium, which was stripped from the crystallizer after the rotary crystallization.

### Example 3

1,164 g of 2N metallurgical-grade crude tellurium was weighed and placed into a rotary roasting furnace, 550 mL of sulfuric acid with a mass concentration of 98% was added thereto, and a protective gas was introduced, and a resulting mixture was then subjected to oxidation roasting (at a temperature of 550° C. for 120 min).

After the oxidation roasting was completed, a low-selenium tellurium dioxide was taken out, and mixed as a raw material with sodium hydroxide to prepare a solution (in which a concentration of tellurium was 140 g/L and a concentration of sodium hydroxide was 93 g/L), and the solution was subjected to electrolysis (the electrolysis was conducted for 48 h at a temperature of 35° C. with a current density of 55 A/m²; a circulating rate of the solution was 5 mL/s; the solution first passed through a cathode chamber and a separator successively, then flowed into an anode chamber, then flowed out of an electrolytic cell, and is collected and sent to liquid purification system to be adjusted to change electrolyzed solution into original solution again, and then enters the cathode chamber for circulation; and an anode used for the electrolysis was an ordinary steel plate, and a cathode used for the electrolysis was a stainless steel) to obtain electrolytic tellurium with a purity of 99.98%.

The electrolytic tellurium was added into a quartz crucible, the quartz crucible was placed into a vacuum distillation furnace at 500° C., the vacuum distillation furnace was vacuumed to a vacuum degree of 10 Pa, and vacuum distillation was conducted for 180 min to obtain 5N tellurium with a purity of 99.9999%.

The 5N tellurium obtained after the vacuum distillation was added as a raw material into a graphite crucible, the graphite crucible was placed into a rotary crystallization furnace, the 5N tellurium was melted in a protective gas atmosphere and subjected to rotary crystallization at a micro-negative pressure of 70,000 Pa (an immersion depth of a crystallizer in a melt was 55 mm; a temperature of the melt was 482° C.; after the crystallizer with an initial temperature of 470° C. was immersed in the melt for 45 min, compressed air at 20° C. was introduced into the crystallizer for cooling to a desired crystallization temperature of 425° C.; a rotational speed of the graphite crucible was 60 r/min; and the rotary crystallization was conducted for 120 min) to obtain 7N ultra-high-purity tellurium, which was stripped from the crystallizer after the rotary crystallization.

The above are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

1. A method for preparing 7N tellurium, comprising the following steps:
mixing 2N crude tellurium with concentrated sulfuric acid, and subjecting a resulting mixture to oxidation roasting to obtain a selenium dioxide vapor and a roasting residue;
mixing the roasting residue with a strong base solution, and subjecting a resulting solution to electrolysis to obtain 4N electrolytic tellurium;
subjecting the 4N electrolytic tellurium to vacuum distillation to obtain 5N tellurium; and
melting the 5N tellurium to obtain a tellurium melt, immersing a crystallizer in the tellurium melt, and subjecting the tellurium melt to crystallization to obtain the 7N tellurium;
wherein the method is performed for a total time of less than 14 days.

2. The method according to claim 1, wherein a mass ratio of the 2N crude tellurium to the concentrated sulfuric acid is in a range of (1-3):1, and a mass concentration of the concentrated sulfuric acid is 98%.

3. The method according to claim 1, wherein the oxidation roasting is conducted at a temperature of 350° C. to 600° C. for 0.5 h to 3 h.

4. The method according to claim 1, wherein in the resulting solution, a concentration of tellurium is in a range of 100 g/L to 300 g/L and a concentration of the strong base is in a range of 90 g/L to 130 g/L.

5. The method according to claim 1, wherein the electrolysis is conducted for 50 h to 110 h at a temperature of 30° C. to 50° C. with a current density of 45 A/m² to 55 A/m²; and during the electrolysis, the resulting solution is in a circulating state with a circulating rate of 1 mL/s to 5 mL/s.

6. The method according to claim 1, wherein the vacuum distillation is conducted at a temperature of 450° C. to 600° C. and a vacuum degree of 0 Pa to 100 Pa.

7. The method according to claim 1, wherein the tellurium melt has a temperature of 460° C. to 560° C.

8. The method according to claim 1, wherein an immersion depth of the crystallizer is 50 mm to 100 mm below a liquid level of the tellurium melt.

9. The method according to claim 1, wherein the crystallizer has an initial temperature of 460° C. to 500° C., and after the crystallizer is immersed for 10 min to 60 min, a temperature of the crystallizer is reduced to 420° C. to 440° C.

10. The method according to claim 1, wherein the crystallization comprises static crystallization and rotary crystallization, and a rotational speed for the rotary crystallization is less than 120 r/min.

11. The method according to claim 2, wherein the oxidation roasting is conducted at a temperature of 350° C. to 600° C. for 0.5 h to 3 h.

12. The method according to claim 4, wherein the electrolysis is conducted for 50 h to 110 h at a temperature of 30° C. to 50° C. with a current density of 45 A/m² to 55 A/m²; and during the electrolysis, the resulting solution is in a circulating state with a circulating rate of 1 mL/s to 5 mL/s.

13. The method according to claim 7, wherein an immersion depth of the crystallizer is 50 mm to 100 mm below a liquid level of the tellurium melt.

14. The method according to claim 7, wherein the crystallizer has an initial temperature of 460° C. to 500° C., and after the crystallizer is immersed for 10 min to 60 min, a temperature of the crystallizer is reduced to 420° C. to 440° C.

15. The method according to claim 7, wherein the crystallization comprises static crystallization and rotary crystallization, and a rotational speed for the rotary crystallization is less than 120 r/min.
